(19) United States
(12) Patent Application Publication
(10) Pub. No.: US 2011/0302357 A1
(43) Pub. Date: Dec. 8, 2011

(54) SYSTEMS AND METHODS FOR DYNAMIC MULTI-LINK COMPILATION PARTITIONING

(76) Inventor: Jason A. Sullivan, Salt Lake City, UT (US)

(21) Appl. No.: 13/153,189

(22) Filed: Jun. 3, 2011

Related U.S. Application Data
(60) Provisional application No. 61/352,368, filed on Jun. 7, 2010.
(60) Provisional application No. 61/352,363, filed on Jun. 7, 2010.
(60) Provisional application No. 61/352,351, filed on Jun. 7, 2010.
(60) Provisional application No. 61/352,372, filed on Jun. 7, 2010.

(51) Int. Cl. G06F 12/02; G06F 13/20; H04N 7/01

(52) U.S. Cl. 711/103; 348/441; 710/313; 348/E07.003; 711/E12.008

(57) ABSTRACT

Systems and methods for dynamic multi-link compilation partitioning. In particular, some implementations of the present invention relate to systems and methods for connecting a computer processing unit to a video display through the use of a wide variety of video display connectors. The present invention further relates to a dynamic interface incorporating USB, PCI-express, SATA, I²C, and power management bus (PMBus) technologies. Further still, some implementations of the present invention relate to an openly connected dynamic storage system whereby the storage capacity of a processing unit is increased by coupling additional storage components to the processing unit via a dynamic interface connector that is interposedly connected. Some implementations of the invention further relate to a customizable grouping of PCIe lanes to provide for a flexible allocation of the lanes to customize the characteristic of the board set, while reducing the power consumption, improving the bandwidth and speed of the device, reducing the cost of the device and providing serial data transfer architecture to provide multiple busses.

### RELATED APPLICATIONS

This application claims priority to U.S. Provisional Patent Application Ser. No. 61/352,368 titled “MULTI-LINK DYNAMIC BUS PARTITIONING” filed Jun. 7, 2010, U.S. Provisional Patent Application Ser. No. 61/352,363 titled “SYSTEMS AND METHODS FOR PROVIDING MULTI-LINK DYNAMIC VIDEO PARTITIONING” filed Jun. 7, 2010, U.S. Provisional Patent Application Ser. No. 61/352,351 titled “SYSTEMS AND METHODS FOR PROVIDING A MULTI-LINK DYNAMIC PCIE PARTITIONING” filed Jun. 7, 2010, and U.S. Provisional Patent Application Ser. No. 61/352,372 titled “MULTI-LINK DYNAMIC STORAGE PARTITIONING” filed Jun. 7, 2010, all of which is expressly incorporated herein by reference, in their entireties.

### BACKGROUND OF THE INVENTION

1. Field of the Invention

The present invention relates to various systems and methods for dynamic multi-link compilation partitioning. In particular, some implementations of the present invention relate to systems and methods for connecting a computer processing unit to a video display through the use of a wide variety of video display connectors. The present invention further relates to a dynamic interface incorporating USB, PCI-express, SATA, I²C, and power management bus (PMBus) technologies. Further still, some implementations of the present invention relate to an openly connected dynamic storage system whereby the storage capacity of a processing unit is increased by coupling additional storage components to the processing unit via a dynamic interface connector that is interposedly connected. Some implementations of the invention further relate to a customizable grouping of PCIe lanes to provide for a flexible allocation of the lanes to customize the characteristic of the board set, while reducing the power consumption, improving the bandwidth and speed of the device, reducing the cost of the device and providing serial data transfer architecture to provide multiple busses.

2. Background and Related Art

Technological advancements have occurred over the years with respect to computer related technologies. For example, computer systems once employed vacuum tubes. The tubes were replaced with transistors. Magnetic cores were used for memory. Thereafter, punch cards and magnetic tapes were commonly employed. Integrated circuits and operating systems were introduced. Today, microprocessor chips are used in computer systems.

The evolution of computer related technologies has included the development of various interface specifications to establish communication between devices and a host controller, such as a personal computer. Such interface specifications include serial and parallel ports, SCSI, Universal Serial Bus (USB), Peripheral Component Interconnect (PCI/PCI-X), PCI-express (PCIe), PMBus, EIDE, SATA, IEEE 1394, and I²C. The interface specifications typically include a physical key whereby the port and connector are coupled to align the necessary pins and contacts.

An interface specification is typically used to operably connect a single peripheral device to various computer components of a host controller via a bus subsystem. Once connected, the interface specification is occupied thereby preventing additional communication with a separate peripheral device. Therefore, the ability to access the host controller is generally limited by the number and variety of interface specifications operably connected to the bus subsystem.

For some devices, a hybrid-interface specification may be used to provide a port and/or connector having physical features whereby to accept operable coupling of one or more interface specification. For example, some hybrid connectors include contact configurations to enable connection to either a USB or a SATA port. Conversely, some hybrid ports include a contact configuration to receive either a USB or a SATA connector. However, neither of these hybrid devices enables simultaneous access or communication between the peripheral device and both the USB and SATA specifications. Rather, access to the BUS subsystem is limited to either the USB or SATA specification, dependent upon the proper operable mating between the port and the connector.

Some hybrid-interface connectors combine an interface specification with a power line, such as USB 2.0. However, these connectors still only provide a single interface specification whereby to access the BUS subsystem of the host controller. Further, once the interface specification is occupied by a peripheral device, additional access to the host controller by another peripheral device is precluded through the occupied specification.

Similarly, modern conventional computer systems utilize Peripheral Component Interconnect (PCI) slots which are an integral part of a computer's architecture. PCI has been a versatile, functional way to connect sound, video and network cards to a motherboard. The speed of networks, processors, video cards and sound cards have improved and become more powerful, PCI retained its fixed width of 32 bits and can handle only 5 devices at a time. In contrast, PCIe technology has advanced beyond the PCI standard to provide point-to-point serial links. A pair of these links forms a lane and are grouped according to device, thus users run related groups of PCIe signals to a connector. Requiring groups to be related limits flexibility of allocating lanes based on needs.

While conventional laptop and personal computers are often able to be connected to one or two displays having specific display connectors, in many cases, if a user wants additional display capabilities, the user will have to attach a video plug-in card to his or her computer. For instance, where the user has a computer comprising one type of display connector and has a video display that requires another type of connector, the user may have to install a plug-in video card before being able to electrically connect the computer to the display. For example, where a user has a laptop that only includes two S-video connectors and the user desires to connect the laptop to a display that requires an HDMI connector, the user may have to place an HDMI plug-in card in his or her laptop before being able to connect the computer to the HDMI display.

While plug-in cards have proven to be useful for enabling a computer system to be connected with a video display that requires a video display connector that was not originally included on the computer system, some such cards also have shortcomings. For instance, some plug-in video cards can be expensive, require a user to open the computer to insert the card, take up additional real estate in a computer's housing, and/or otherwise be inconvenient to use.

Further, in contemporary usage the term “storage” usually refers to mass storage, such as optical discs and forms of magnetic storage like hard disk drives. Further evolutions of computer related technologies have included the development of the solid-state drive (SSD). An SSD is a data storage device that uses solid-state memory to store persistent data. An SSD emulates a hard disk drive interface, thus easily replacing it most applications. With no moving parts, SSDs are less fragile than hard disks and are also silent. As there are no mechanical delays, SSDs usually enjoy low access time and latency.

All forms of memory or storage have a limited data storage capacity, and therefore required constant upgrading or maintenance to delete unwanted data to free up storage space. A common practice among computer users is to upgrade a storage device with a new storage device having increased storage capacity. When a new storage drive is added, the processing unit recognizes the new drive as a separate and independent storage device from the old drive. For example, if the old storage drive has a capacity of 80 gigabytes, and the new storage drive has a storage capacity of 320 gigabytes, the processing unit recognizes two separate storage drives rather than combining the storage to recognize a single drive having 400 gigabytes of storage. As such, the process of upgrading a storage device generally involves transferring data from the old drive to the new drive. The old drive is then discarded or kept as a secondary or auxiliary drive while the new drive replaces the function of the old. This process can be expensive, time consuming and result in unwanted loss of important data.

Thus, while technologies currently exist that are configured for use in peripheral device communication, challenges still exist. Accordingly, it would be an improvement in the art to augment or even replace current techniques with other techniques.

### SUMMARY OF THE INVENTION

The present invention relates to various systems and methods for dynamic multi-link compilation partitioning. A summary of the various systems and methods of the present invention is as follows:

### Multi-Link Dynamic Video Partitioning

Some aspects of the present invention relate to computer systems and methods for connecting such systems to electronic video displays. In particular, some aspects of the present invention relate to systems and methods for connecting a computer processing unit to a video display through the use of a wide variety of video display connectors.

Implementation of some features of the present invention take place in association with a computer processing unit that includes a first printed circuit board that includes a central processing unit. In some non-limiting implementations, the first board is routed to electrically connect with multiple boards, such as an input/output board and/or a power supply board, that each has a different combination or configuration of one or more video display connectors. In such implementations, the processing unit comprises BIOS information for each of the different contemplated combinations/configurations of video display connectors. Accordingly, when an input/output board and/or a power supply board is connected to the first board, the computer processing unit is able to interrogate, or auto sense, the added board to determine what video connectors that board includes. Upon determining the type of video connectors on the added board, the system identifies the appropriate BIOS information for the connectors and is able to run one or more electronic displays through such connectors.

The described computer processing unit can include any suitable type of video display connector, including, but not limited to, one or more DVI, VGA, S-video, DisplayPort, HDMI, extended graphics, and/or other known or novel connectors that are capable of electrically connecting the processing unit to one or more electronic video displays. In some non-limiting implementations, however, the computer processing unit comprises a DVI connector and a DisplayPort connector. In some such implementations, the DVI connector is configured to provide both DVI and VGA signals through the same DVI connector.

Where the computer processing unit comprises one or more display connectors, such as a DVI connector and a DisplayPort connector, the processing unit can be configured in any suitable manner to electrically attach to one or more video displays that require a variety of different types of video connectors. Indeed, in one non-limiting example, the computer processing unit uses one or more adaptors, such as a dongle adaptor, to connect the processing unit's display connectors (e.g., DVI and/or DisplayPort connectors) to one or more electronic displays that require a type of video connector that is different from a DVI or DisplayPort connector.

While some of the methods and processes of the present invention have proven to be particularly useful in the area of electrically connecting laptops and personal computers to video displays through a wide variety of display connectors, those skilled in the art can appreciate that the described methods and processes can be used in a variety of different applications and in a variety of different areas of manufacture to connect any suitable type of computer to any suitable type of video display, through the use of any suitable type of video display connector.

### Multi-Link Dynamic Bus Partitioning

Some aspects of the present invention relate to a dynamic interface incorporating multiple technologies. In particular, at least some implementations of the present invention relate to a dynamic interface incorporating USB, PCI-express, SATA, I²C, and power management bus (PMBus) technologies. In some implementations, the dynamic interface is used in combination with a processing unit which includes a non-peripheral based encasement, a cooling process (e.g., thermodynamic convection cooling, forced air, and/or liquid cooling), an optimized circuit board configuration, optimized processing and memory ratios, and a dynamic back plane that provides increased flexibility and support to peripherals and applications.

In some implementations, a dynamic interface is provided incorporating a plurality of interface technologies, whereby the dynamic interface is directly and operably connected to a system bus of a processing unit. The dynamic interface further includes a connection means whereby the dynamic interface is operably connected to one or more peripheral devices. The one or more peripheral devices may include any desired function and generally requires communication with the processing unit via the system bus and dynamic interface.

In some implementation, a peripheral device includes a plurality of ASICs, each ASIC being configured to communicate with the system bus via a specific interface technology. Thus, in some implementations a peripheral device is configured to include multiple and diverse circuits whereby to provide access to the system bus and functionality to the peripheral device.

### Multi-Link Dynamic Storage Partitioning

Some aspects of the present invention relate to a system and method for providing an expandable storage drive. In particular, some aspects of the present invention relate to an openly connected dynamic storage system whereby the storage capacity of a processing unit is increased by coupling additional storage components to the processing unit via a dynamic interface connector that is interposedly connected.

In some implementations, a dynamic storage drive is provided having means whereby the storage capacity of the drive is expandable. In some implementations, a processing unit is provided having a dynamic storage interface for dynamically receiving storage modules. In other implementations, a dynamic peripheral storage interface is provided for dynamically receiving peripheral storage devices, the storage interface being operably coupled to a system bus of the processing unit.

Some aspects of the present invention further provide a method by which a storage capacity of an existing processing unit is expanded to a greater storage capacity by dynamically adding storage modules to the processing unit.

### Multi-Link Dynamic PCIE Partitioning

Further, some aspects of the present invention provide for flexibility in splitting and or grouping unrelated lanes on a single PCIe connector. Still further, some aspects of the present invention relate to a customizable grouping of PCIe lanes to provide for a flexible allocation of the lanes to customize the characteristic of the board set, while reducing the power consumption, improving the bandwidth and speed of the device, reducing the cost of the device and providing multiple busses.

Particularly, some representative embodiments of the present invention improve upon existing computers and computing systems and methods, and can, in some instances, be used to overcome one or more problems associated with or related to such existing systems and methods.

In accordance with the invention as embodied and broadly described herein, some aspects of the present invention feature a robust customizable computing system comprising: a motherboard having a chip disposed thereon; a PCIe slot connected to the motherboard and a card coupled to the PCIe slot; initiating the bios on the chip; determining the number of lanes required for the devices on the card and allocating lanes to those devices to maximize performance of the card.

While some of the methods and processes of the present invention have proven to be particularly useful in the area of personal computing enterprises, those skilled in the art can appreciate that the methods and processes of the present invention can be used in a variety of different applications and in a variety of different areas of manufacture to yield robust customizable enterprises, including enterprises for any industry utilizing control systems or smart-interface systems and/or enterprises that benefit from the implementation of such devices. Examples of such industries include, but are not limited to, automotive industries, avionic industries, hydraulic control industries, auto/video control industries, telecommunications industries, medical industries, special application industries, and electronic consumer device industries. Accordingly, the systems and methods of the present invention provide customizable and flexible computing power to markets, including markets that have traditionally been untapped by current computer techniques.

Some aspects of the present invention further feature a method for introducing intelligence into an external object and enabling smart functions therein. The method comprises: obtaining an external object; operably connecting a processing control unit to the external object; and initiating one or more computing functions within the processing control unit to cause the external object to perform smart functions.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order to set forth the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates a representative networked computer system for use with representative embodiments of the invention;

FIG. 3 illustrates a representative embodiment of a computer processing unit;

FIG. 4 is a schematic view of a processing unit, a dynamic interface and a peripheral device in accordance with a representative embodiment of the present invention;

FIG. 5 is a schematic view of a dynamic interface and a peripheral device in accordance with a representative embodiment of the present invention;

FIG. 6 is a schematic view of a dynamic interface and a peripheral device in accordance with a representative embodiment of the present invention;

FIG. 7 is a schematic view of a dynamic interface and a peripheral device in accordance with a representative embodiment of the present invention;

FIG. 8 is a schematic view of a dynamic interface, a first peripheral device, and a second peripheral device in accordance with a representative embodiment of the present invention;

FIG. 9 is a schematic view of a processing unit, a dynamic interface and a peripheral device in accordance with a representative embodiment of the present invention;

FIG. 10 is a flow chart of a method for dynamically growing the storage capacity of a processing unit in accordance with a representative embodiment of the present invention;

FIG. 11 is a cross-section view of a dynamic interface and storage modules in accordance with a representative embodiment of the present invention;

FIG. 12 is a schematic view of a dynamic interface and a peripheral device in accordance with a representative embodiment of the present invention;

FIG. 13 is a schematic view of a dynamic interface, a first peripheral device, and a second peripheral device in accordance with a representative embodiment of the present invention;

FIG. 14, as shown in parts A through C, is a schematic view of various configurations of peripheral storage devices in accordance with representative embodiments of the present invention;

FIG. 15, as shown in parts A through D, is a schematic view of various stacked configurations of peripheral storage devices in accordance with representative embodiments of the present invention;

FIG. 16 is a flow chart of a method for dynamically growing the storage capacity of a processing unit in accordance with a representative embodiment of the present invention; and

FIG. 17 is a schematic of a representative PCIe bridge and corresponding lanes.

### DETAILED DESCRIPTION OF THE INVENTION

The present invention relates to various systems and methods for dynamic multi-link compilation partitioning.

### Multi-Link Dynamic Video Partitioning

At least some embodiments of the present invention relate to computer systems and methods for connecting such systems to electronic video displays. In particular, the present invention relates to systems and methods for connecting a computer processing unit to a video display through the use of a wide variety of video display connectors.

In the disclosure and in the claims, the term electronic video display and variations thereof may refer to virtually any electronic visual display unit that can be connected to a computer. Some example of suitable electronic video displays include, but are not limited to, computer monitors (i.e., LCD, CRT, plasma, and other types of computer screens), television sets, projectors, and other known or novel display units.

Additionally, as used herein, the term video display connector can refer to any suitable connection mechanism that is capable of electrically connecting a computer processing unit to a video display. Some non-limiting examples of suitable display connectors include DVI, VGA, S-video, DisplayPort, HDMI, extended graphics ports, and other known or novel display connectors.

The following disclosure of the present invention is grouped into two subheadings, namely “Representative Operating Environment” and “Multi-Link Dynamic Video Partitioning.” The utilization of the subheadings is for convenience of the reader only and is not to be construed as limiting in any sense.

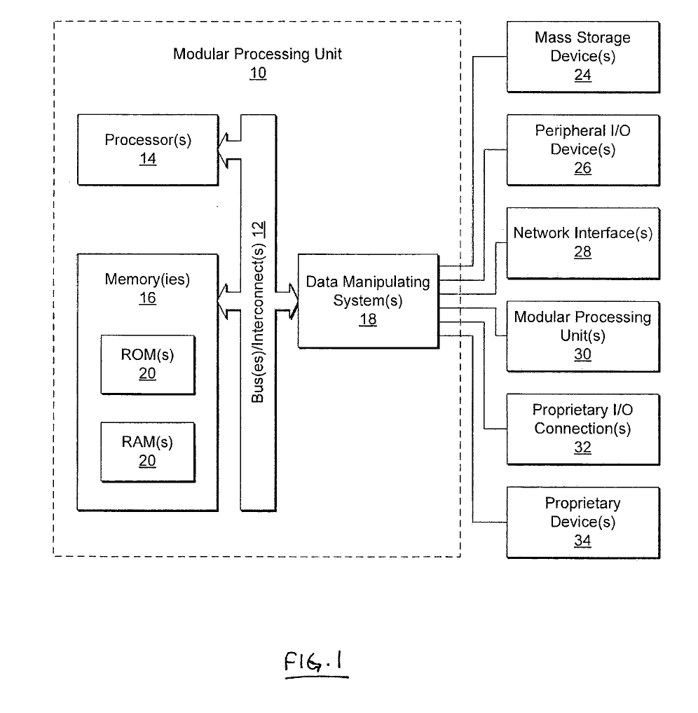

FIG. 1 and the corresponding discussion are intended to provide a general description of a suitable operating environment in accordance with embodiments of the present invention. As will be further discussed below, embodiments of the present invention embrace the use of one or more dynamically modular processing units in a variety of customizable enterprise configurations, including in a networked or combination configuration, as will be discussed below.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by one or more processors, such as one associated with a general-purpose modular processing unit capable of performing various different functions or one associated with a special-purpose modular processing unit capable of performing a limited number of functions.

Computer executable instructions cause the one or more processors of the enterprise to perform a particular function or group of functions and are examples of program code means for implementing steps for methods of processing. Furthermore, a particular sequence of the executable instructions provides an example of corresponding acts that may be used to implement such steps.

Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), any solid state storage device (e.g., flash memory, smart media, etc.), or any other device or component that is capable of providing data or executable instructions that may be accessed by a processing unit.

With reference to FIG. 1, a representative enterprise includes modular processing unit 10, which may be used as a general-purpose or special-purpose processing unit. For example, modular processing unit 10 may be employed alone or with one or more similar modular processing units as a personal computer, a notebook computer, a personal digital assistant (“PDA”) or other hand-held device, a workstation, a minicomputer, a mainframe, a supercomputer, a multi-processor system, a network computer, a processor-based consumer device, a smart appliance or device, a control system, or the like. Using multiple processing units in the same enterprise provides increased processing capabilities. For example, each processing unit of an enterprise can be dedicated to a particular task or can jointly participate in distributed processing.

In FIG. 1, modular processing unit 10 includes one or more buses and/or interconnect(s) 12, which may be configured to connect various components thereof and enables data to be exchanged between two or more components. Bus(es)/interconnect(s) 12 may include one of a variety of bus structures including a memory bus, a peripheral bus, or a local bus that uses any of a variety of bus architectures. Typical components connected by bus(es)/interconnect(s) 12 include one or more processors 14 and one or more memories 16. Other components may be selectively connected to bus(es)/interconnect(s) 12 through the use of logic, one or more systems, one or more subsystems and/or one or more I/O interfaces, hereafter referred to as “data manipulating system(s) 18.” Moreover, other components may be externally connected to bus(es)/interconnect(s) 12 through the use of logic, one or more systems, one or more subsystems and/or one or more I/O interfaces, and/or may function as logic, one or more systems, one or more subsystems and/or one or more I/O interfaces, such as modular processing unit(s) 30 and/or proprietary device(s) 34. Examples of I/O interfaces include one or more mass storage device interfaces, one or more input interfaces, one or more output interfaces, and the like. Accordingly, embodiments of the present invention embrace the ability to use one or more I/O interfaces and/or the ability to change the usability of a product based on the logic or other data manipulating system employed.

The logic may be tied to an interface, part of a system, subsystem and/or used to perform a specific task. Accordingly, the logic or other data manipulating system may allow, for example, for IEEE1394 (firewire), wherein the logic or other data manipulating system is an I/O interface. Alternatively or additionally, logic or another data manipulating system may be used that allows a modular processing unit to be tied into another external system or subsystem. For example, an external system or subsystem that may or may not include a special I/O connection. Alternatively or additionally, logic or other data manipulating system may be used wherein no external I/O is associated with the logic. Embodiments of the present invention also embrace the use of specialty logic, such as for ECUs for vehicles, hydraulic control systems, etc. and/or logic that informs a processor how to control a specific piece of hardware. Moreover, those skilled in the art will appreciate that embodiments of the present invention embrace a plethora of different systems and/or configurations that utilize logic, systems, subsystems and/or I/O interfaces.

As provided above, embodiments of the present invention embrace the ability to use one or more I/O interfaces and/or the ability to change the usability of a product based on the logic or other data manipulating system employed. For example, where a modular processing unit is part of a personal computing system that includes one or more I/O interfaces and logic designed for use as a desktop computer, the logic or other data manipulating system may be changed to include flash memory or logic to perform audio encoding for a music station that wants to take analog audio via two standard RCAs and broadcast them to an IP address. Accordingly, the modular processing unit may be part of a system that is used as an appliance rather than a computer system due to a modification made to the data manipulating system(s) (e.g., logic, system, subsystem, I/O interface(s), etc.) on the back plane of the modular processing unit. Thus, a modification of the data manipulating system(s) on the back plane can change the application of the modular processing unit. Accordingly, embodiments of the present invention embrace very adaptable modular processing units.

As provided above, processing unit 10 includes one or more processors 14, such as a central processor and optionally one or more other processors designed to perform a particular function or task. It is typically processor 14 that executes the instructions provided on computer readable media, such as on memory(ies) 16, a magnetic hard disk, a removable magnetic disk, a magnetic cassette, an optical disk, or from a communication connection, which may also be viewed as a computer readable medium.

Memory(ies) 16 includes one or more computer readable media that may be configured to include or includes thereon data or instructions for manipulating data, and may be accessed by processor(s) 14 through bus(es)/interconnect(s) 12. Memory(ies) 16 may include, for example, ROM(s) 20, used to permanently store information, and/or RAM(s) 22, used to temporarily store information. ROM(s) 20 may include a basic input/output system (“BIOS”) having one or more routines that are used to establish communication, such as during start-up of modular processing unit 10. During operation, RAM(s) 22 may include one or more program modules, such as one or more operating systems, application programs, and/or program data.

As illustrated, at least some embodiments of the present invention embrace a non-peripheral encasement, which provides a more robust processing unit that enables use of the unit in a variety of different applications. In FIG. 1, one or more mass storage device interfaces (illustrated as data manipulating system(s) 18) may be used to connect one or more mass storage devices 24 to bus(es)/interconnect(s) 12. The mass storage devices 24 are peripheral to modular processing unit 10 and allow modular processing unit 10 to retain large amounts of data. Examples of mass storage devices include hard disk drives, magnetic disk drives, tape drives and optical disk drives.

A mass storage device 24 may read from and/or write to a magnetic hard disk, a removable magnetic disk, a magnetic cassette, an optical disk, or another computer readable medium. Mass storage devices 24 and their corresponding computer readable media provide nonvolatile storage of data and/or executable instructions that may include one or more program modules, such as an operating system, one or more application programs, other program modules, or program data. Such executable instructions are examples of program code means for implementing steps for methods disclosed herein.

Data manipulating system(s) 18 may be employed to enable data and/or instructions to be exchanged with modular processing unit 10 through one or more corresponding peripheral I/O devices 26. Examples of peripheral I/O devices 26 include input devices such as a keyboard and/or alternate input devices, such as a mouse, trackball, light pen, stylus, or other pointing device, a microphone, a joystick, a game pad, a satellite dish, a scanner, a camcorder, a digital camera, a sensor, and the like, and/or output devices such as a monitor or display screen, a speaker, a printer, a control system, and the like. Similarly, examples of data manipulating system(s) 18 coupled with specialized logic that may be used to connect the peripheral I/O devices 26 to bus(es)/interconnect(s) 12 include a serial port, a parallel port, a game port, a universal serial bus (“USB”), a firewire (IEEE 1394), a wireless receiver, a video adapter, an audio adapter, a parallel port, a wireless transmitter, any parallel or serialized I/O peripherals or another interface.

Data manipulating system(s) 18 enable an exchange of information across one or more network interfaces 28. Examples of network interfaces 28 include a connection that enables information to be exchanged between processing units, a network adapter for connection to a local area network (“LAN”) or a modem, a wireless link, or another adapter for connection to a wide area network (“WAN”), such as the Internet. Network interface 28 may be incorporated with or peripheral to modular processing unit 10, and may be associated with a LAN, a wireless network, a WAN and/or any connection between processing units.

Data manipulating system(s) 18 enable modular processing unit 10 to exchange information with one or more other local or remote modular processing units 30 or computer devices. A connection between modular processing unit 10 and modular processing unit 30 may include hardwired and/or wireless links. Accordingly, embodiments of the present invention embrace direct bus-to-bus connections. This enables the creation of a large bus system. It also eliminates hacking as currently known due to direct bus-to-bus connections of an enterprise. Furthermore, data manipulating system(s) 18 enable modular processing unit 10 to exchange information with one or more proprietary I/O connections 32 and/or one or more proprietary devices 34.

Program modules or portions thereof that are accessible to the processing unit may be stored in a remote memory storage device. Furthermore, in a networked system or combined configuration, modular processing unit 10 may participate in a distributed computing environment where functions or tasks are performed by a plurality of processing units. Alternatively, each processing unit of a combined configuration/enterprise may be dedicated to a particular task. Thus, for example, one processing unit of an enterprise may be dedicated to video data, thereby replacing a traditional video card, and provides increased processing capabilities for performing such tasks over traditional techniques.

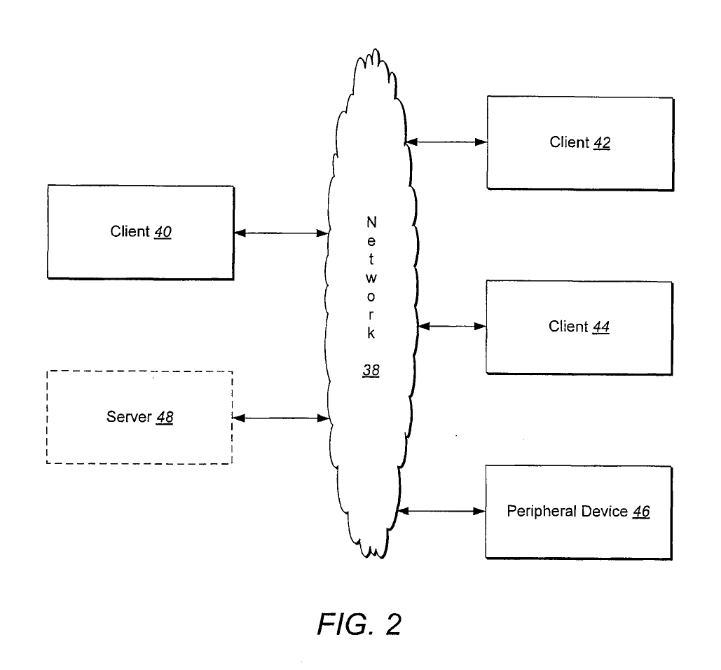

Thus, while those skilled in the art will appreciate that embodiments of the present invention may be practiced in a variety of different environments with many types of system configurations, FIG. 2 provides a representative networked system configuration that may be used in association with certain embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

As discussed above, the described systems and methods for providing multi-link, dynamic video partitioning can be used to connect any suitable computer processing unit to a video display through the use of a variety of video display connectors.

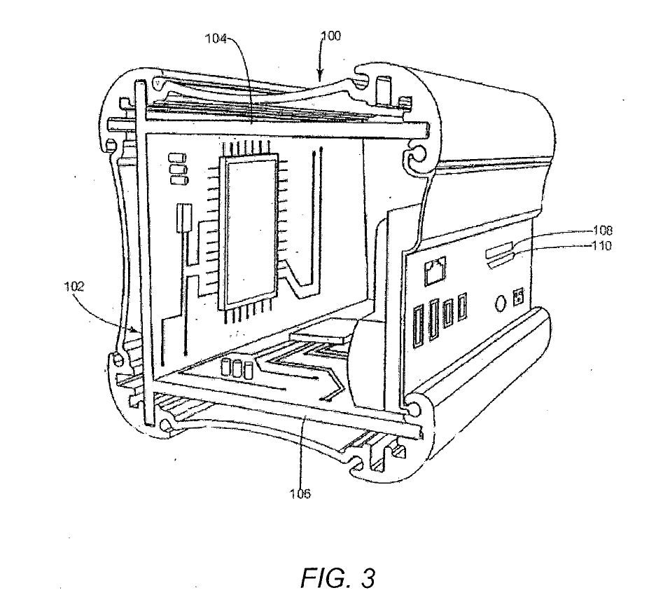

With specific reference to the computer processing unit, in some non-limiting embodiments, the computer processing unit comprises a single motherboard that is electrically connected to one or more video display connectors that, in turn, can be connected to one or more video displays. In other non-limiting embodiments, however, the computer processing unit comprises a plurality of boards, wherein one or more boards in the unit are electrically connected to one or more video display connectors. In some further non-limiting embodiments, where the processing unit comprises more than one printed circuit board, more than one card is require for the processing unit to function properly.

Where the computer processing unit comprises two or more required boards, the unit can comprise any suitable number of boards, including, but not limited to, 2, 3, 4, 5, or more. In one example, FIG. 3 illustrates a non-limiting embodiment in which the computer processing unit 100 comprises three printed circuit boards, namely a first 102, a second 104, and a third 106 electrical printed circuit board.

In embodiments in which processing unit 100 includes three boards, the various boards may perform any suitable function. Indeed, in one non-limiting example, one or more of the boards (e.g., the first board 102) comprises at least one central processing unit (“CPU”) and optionally includes one or more other processors (such as a video controller) that are designed to perform one or more particular functions or tasks. As a result, the processing unit 100 is able to execute the operations, and specifically, to execute any instructions provided on a computer readable media, such as on a memory device, a magnetic hard disk, a removable magnetic disk, a magnetic cassette, an expandable memory device, a disk (e.g., CD-ROM's, DVD's, floppy disks, etc.), or from a remote communications connection, which may also be viewed as a computer readable medium.

In another non-limiting example of a function that can be performed by one of a plurality of boards, in some non-limiting embodiments, one of the boards (e.g., the second board 104) functions as a power supply board (“PS board”) and further comprises logic for one or more input/output ports (e.g., one or more video display connectors, Ethernet connectors, ePCle connectors, etc.). In some non-limiting embodiments, this second board 104 also functions as a northbridge that handles communications between the CPU, RAM, AGP, and other electrical components of the processing unit 100.

In still another example of a function that can be performed by one of the plurality of boards, in some non-limiting embodiments, one or more of the boards (e.g., the third board 106) functions as an input/output board (“I/O board”) (e.g., as a southbridge). In such embodiments, the southbridge circuit board (e.g., the third board 106) comprises logic for some or all of the input/output ports that are electrically connected to the processing unit 100. Additionally, in one non-limiting example, the southbridge comprises logic for one or more XGP connectors, eSATA connectors, USB connectors, audio connectors, video display connectors, etc.

Where the computer processing unit 100 comprises more than one printed circuit board, the various boards can be electrically connected to each other in any suitable manner, including, without limitation, through the use of board-to-board physical connectors and/or ribbon connectors. However, because board-to-board physical connectors can require less space, offer a stronger connection, and allow for more efficient routing on the printed circuit boards, such connectors are preferred in some non-limiting embodiments.

In some non-limiting embodiments in which the computer processing unit comprises a plurality of printed boards, the processing unit is configured to be attached to a variety of video display connectors. In such embodiments, the processing unit can be electrically connected to one or more video display adaptors in any suitable manner.

In one non-limiting embodiment, the first board (e.g., the CPU board 102) is routed so as to have the proper traces for a variety of different combinations of display connectors. In other words, in some non-limiting embodiments, the first board is configured to be connected to a variety of different I/O boards (e.g., third boards 106) and/or PS boards (e.g., second boards 104) that each have a different combination of one or more display connectors. In such embodiments, the board-to-board physical connectors, ribbon connectors, and/or other connectors between the first board and the PS board and/or I/O boards comprise all of the electrical connections needed to connect the CPU and/or video controller to multiple combinations of display connectors.

Where the computer processing unit is configured to be electrically connected to multiple combinations of display connectors, the unit can be configured to be electrically connected to any suitable combinations of display connectors (e.g., DVI, VGA, S-video, DisplayPort, HDMI, expanded graphics ports, and/or other known or novel display connectors. In one non-limiting example that is provided to better explain the processing unit, where the processing unit 100 comprises an I/O board (e.g., the third board 106) that includes a single DVI connector and a single DisplayPort connector, the CPU board can be configured to be electrically connected those two connectors as well as to another DVI connector, another, DisplayPort connector, and/or another display connector, such as an HDMI connector. Accordingly, if a user were to decide that the user wanted two DVI connectors and two DisplayPort connectors in the processing unit, the user could simply remove the original I/O board and replace it with another I/O board that has two DVI connectors and two DisplayPort connectors.

In order for the processing unit to allow different combinations of display connectors on the I/O board and/or PS board to function properly with the same CPU board, some non-limiting embodiments of the computer processing unit comprise video BIOS information for multiple types of display connectors. Indeed, the processing unit can programmed to comprise video BIOS information for any known or novel type of display connector, including without limitation, video BIOS information for all types of DVI connectors (e.g., single link DVI-I, dual link DVI-I, single link DVI-D, dual link DVI-D, DVI-A, M1-DA, etc.), VGA, S-video, DisplayPort, HDMI, extended graphics ports, and other display connectors.

Thus, in such embodiments, when an I/O board and/or a PS board having one or more display connectors that are electrically attached to the first board, the processing unit can interrogate the various connectors to determine what type of connector or connectors are electrically attached to the processing unit. Once, the processing unit determines the type or types of connectors that are electrically connected to the processing unit (e.g., via the I/O board and/or PS board), the processing unit (e.g., the video controller and/or the CPU comprising the various video BIOS information) can select one or more applicable video BIOS information from a library of video BIOS information and, thereby, allow the various display connectors to function properly.

In addition to, or in place of, configuring the computer processing unit 100 to include a variety of different display connectors by replacing the I/O board and/or the PS board, in some non-limiting embodiments, the computer processing unit uses one or more adaptors to electrically connect the processing unit to one or more video displays through a variety of video display connectors. In such embodiments, the computer processing unit can be used in conjunction with any suitable adaptor that is capable of transmitting video signal from one type of display connector on the processing unit to another type of display connector that, in turn, is configured to attach to a video display.

Some non-limiting examples of suitable adaptors include dongles, cables, and connectors. More specifically, some examples of suitable adaptors include, but are not limited to a VGA to DVI dongle, a DVI to HDMI dongle, a Y-splitter dongle that comprises a male DVI connector at one end and a female DVI connector and female VGA connector at the other end, a DisplayPort to HDMI dongle, a DisplayPort to DVI dongle (e.g., a DisplayPort to single DVI dongle and a DisplayPort to dual-link DVI dongle), a DisplayPort to VGA dongle, and any other adaptor dongle that is capable of allowing a video display to connect to the processing unit, when the display connectors on the processing unit are not of the type required by the video display.

Thus, through the use of adaptors (e.g., dongles and cables), the processing unit comprising relatively few types of display connectors can be connected to one or more video displays through a wide variety of display connectors. By way of non-limiting illustration, FIG. 3 and the follow list show that where the processing unit 100 (i.e., a processing unit comprising a single motherboard as well as a processing unit comprising a plurality of circuit boards) comprises a DisplayPort connector 108 and a dual-link DVI connector 110, the processing unit can be connected to one or more video displays through a wide variety of display connectors.

In one non-limiting example, where the processing unit comprises a dual-link DVI connector, a single display requiring a dual-link DVI connection can be plugged into the connector on the processing unit. In this example, a Y-splitter DVI to DVI and VGA cable also allows the processing unit to control one dual-link DVI display and one VGA display.

In a second non-limiting example, where the processing unit comprises a dual-link DVI connector, a single display requiring a single-link connector can be connected to and run through the DVI connector on the processing unit. Similarly, in this example, a Y-splitter DVI to DVI and VGA cable also allows the processing unit to control a single-link DVI display and a single VGA display.

In a third non-limiting embodiment, where the processing unit comprises a dual-link DVI connector, a DVI to VGA dongle can allow the processing unit to control a single VGA display and a Y-splitter DVI to DVI and VGA cable allows the processing unit to run a DVI and VGA display.

In a forth non-limiting example, where the processing unit comprises a dual-link DVI connector, a DVI to HDMI dongle allows the connector to run an HDMI display. Similarly, in this example, a Y-splitter DVI to HDMI and DVI cable allows the connector on the display unit to control an HDMI display as well as a DVI or VGA display.

In still another non-limiting, example, where the processing unit 100 comprises a DisplayPort connector, the connector can directly control a DisplayPort display, or through the use of an adaptor, the DisplayPort can control a dual-link DVI display, a single-link DVI display, an HDMI display, and/or a VGA display. Thus, the following non-limiting list shows that where the processing unit comprises one dual-link DVI connector and one DisplayPort connector, the processing unit can control at least 23 different combinations of display types.
1. Dual-Link DVI+DP
2. Dual-Link DVI+Dual-Link DVI (Active Dongle on DP)
3. Dual-Link DVI+Single-Link DVI (Passive Dongle on DP)
4. Dual-Link DVI+HDMI (Passive Dongle on DP)
5. Dual-Link DVI+VGA (Passive Dongle on DP)
6. Dual-Link DVI+VGA (Y-Splitter Cable on DVI)
7. Single-Link DVI+DP
8. Single-Link DVI+Dual-Link DVI (Active Dongle on DP)
9. Single-Link DVI+Single-Link DVI (Passive Dongle on DP)
10. Single-Link DVI+HDMI (Passive Dongle on DP)
11. Single-Link DVI+VGA (Passive Dongle on DP)
12. Single-Link DVI+VGA (Y-Splitter Cable on DVI)
13. VGA (Dongle on DVI)+DP
14. VGA (Dongle on DVI)+Dual-Link DVI (Active Dongle on DP)
15. VGA (Dongle on DVI)+Single-Link DVI (Passive Dongle on DP)
16. VGA (Dongle on DVI)+HDMI (Passive Dongle on DP)
17. VGA (Dongle on DVI)+VGA (Passive Dongle on DP)
18. HDMI (Dongle on DVI)+DP
19. HDMI (Dongle on DVI)+Dual-Link DVI (Active Dongle on DP)
20. HDMI (Dongle on DVI)+Single-Link DVI (Passive Dongle on DP)
21. HDMI (Dongle on DVI)+HDMI (Passive Dongle on DP)
22. HDMI (Dongle on DVI)+VGA (Passive Dongle on DP)
23. HDMI (Dongle on DVI on Y-Splitter Cable on DVI)+VGA (Y-Splitter Cable on DVI)

In addition to the aforementioned configurations, the processing unit can be configured to include any other suitable combination of display connectors, including without limitation, one or more DVI connectors, DisplayPort connectors, extended graphics connectors, and HDMI connectors, S-video connectors, and/or VGA connectors. Indeed, in some non-limiting embodiments, the processing unit comprises a DisplayPort Connector, a DVI connector, and an extended graphics connector. Accordingly, where each connector is used with a Y-splitter, the described processing unit is able to control up to six monitors, simultaneously.

Thus, as discussed herein, some embodiments of the present invention embrace computer systems and methods for connecting such systems to electronic video displays. In particular, some aspects of the present invention relates to systems and methods for connecting a computer processing unit to a video display through the use of a wide variety of video display connectors.

### Multi-Link Dynamic Bus Partitioning

At least some aspects of the present invention further relate to a dynamic interface incorporating multiple technologies. In particular, at least some implementations of the present invention relate to a dynamic interface incorporating USB, PCI-express, SATA, I²C, and power management bus (PMBus) technologies. In some implementations, the dynamic interface is used in combination with a processing unit which includes a non-peripheral based encasement, a cooling process (e.g., thermodynamic convection cooling, forced air, and/or liquid cooling), an optimized circuit board configuration, optimized processing and memory ratios, and a dynamic back plane that provides increased flexibility and support to peripherals and applications.

Some embodiments of the present invention embrace a dynamic interface that may be employed in association with all types of computer and/or electrical enterprises. The port allows for a plethora of communications and expansive modifications to the host controller at the bus level. Moreover, the dynamic interface may function alone or may be associated with one or more other dynamic interfaces in modular fashion to provide enhanced flexibility and utility to the host controller.

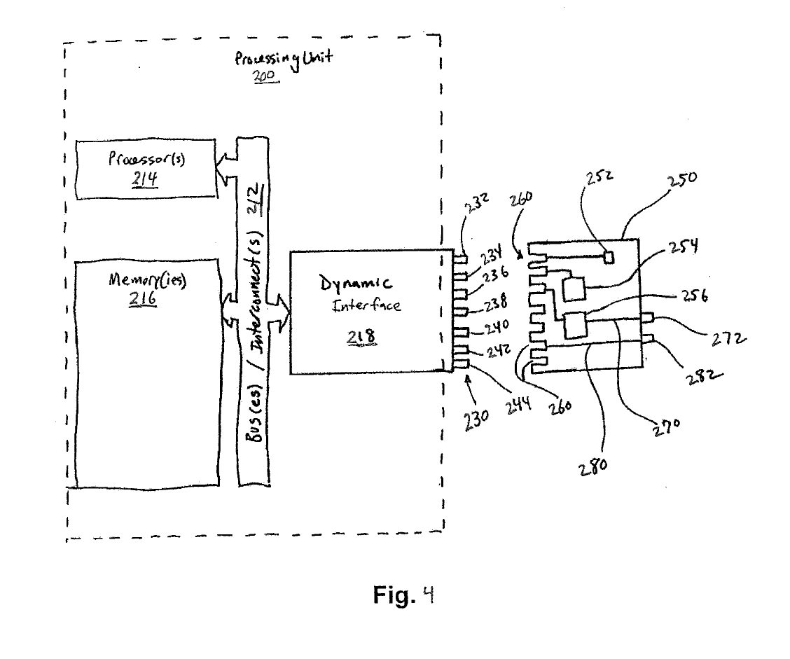

FIG. 4 and the corresponding discussion are intended to provide a general description of a suitable operating environment in accordance with embodiments of the present invention. As will be further discussed below, embodiments of the present invention embrace the use of one or more dynamic interfaces in a variety of customizable configurations, as will be discussed below.

Some embodiments of the present invention embrace one or more computer readable media, wherein each medium may be configured to include or includes thereon data or computer executable instructions for manipulating data. The computer executable instructions include data structures, objects, programs, routines, or other program modules that may be accessed by one or more processors, such as one associated with a general-purpose processing unit capable of performing various different functions or one associated with a special-purpose processing unit capable of performing a limited number of functions.

Computer executable instructions cause the one or more processors of the enterprise to perform a particular function or group of functions and are examples of program code means for implementing steps for methods of processing. Furthermore, a particular sequence of the executable instructions provides an example of corresponding acts that may be used to implement such steps.

Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), any solid state storage device (e.g., flash memory, smart media, etc.), or any other device or component that is capable of providing data or executable instructions that may be accessed by a processing unit.

With continued reference to FIG. 4, a representative host controller includes a processing unit 200, which may be used as a general-purpose or special-purpose processing unit. For example, processing unit 200 may be employed alone or with one or more similar processing units as a personal computer, a notebook computer, a personal digital assistant (“PDA”) or other hand-held device, a workstation, a minicomputer, a mainframe, a supercomputer, a multi-processor system, a network computer, a processor-based consumer device, a smart appliance or device, a control system, or the like. Using multiple processing units in the same host controller provides increased processing capabilities. For example, each processing unit of a host controller can be dedicated to a particular task or can jointly participate in distributed processing.

In FIG. 1, processing unit 200 includes one or more buses and/or interconnect(s) 212, which may be configured to connect various components thereof and enables data to be exchanged between two or more components. Bus(es)/interconnect(s) 212 may include one of a variety of bus structures including a memory bus, a peripheral bus, or a local bus that uses any of a variety of bus architectures. Typical components connected by bus(es)/interconnect(s) 212 include one or more processors 214 and one or more memories 216.

In some embodiments, peripheral components may be selectively connected to bus(es)/interconnect(s) 212 through the use of one or more dynamic interfaces 218. In some embodiments, dynamic interface 218 comprises a plurality of zoned circuits 230. Each circuit provides a high-speed connection and is therefore insulated from an adjacent circuit to prevent radio or electrical interference. Each circuit 230 comprises a desired interface specification thereby providing a dynamic interface 218 having a unique and useful combination of interfacing technologies. For example, in some embodiments a dynamic interface 218 is provided having a plurality zoned circuits 230 which include a variety of specification interface technologies, such as PCIe 232, SATA 234 and 236, USB 238, I²C 240, and PMBus 242. In some embodiments, dynamic interface 218 further includes a power circuit 244.

One having skill in the art will appreciate that dynamic interface 218 may include any type or combination of interface technologies as desired for a specific application. Further, one having skill in the art will appreciate that advances in computing technology may provide additional interface technologies that are compatible with the present invention and are therefore included within the spirit of the present invention.

Zoned circuits 230 provide a plurality of interface technologies 232, 234, 236, 238, 240 and 242 that may be utilized by a peripheral device 250 to access system bus 212. In some embodiments, the interface technologies of zoned circuits 230 are selected so as to provide sufficient interface capabilities for an anticipated peripheral device 250 or devices. Peripheral device 250 may include any electronic device requiring access to system bus 212 or power. Non-limiting examples of peripheral devices 250 include input devices such as a keyboard and/or alternate input devices, such as a mouse, trackball, light pen, stylus, or other pointing device, a microphone, a joystick, a game pad, a satellite dish, a scanner, a camcorder, a digital camera, a sensor, and the like, and/or output devices such as a monitor or display screen, a speaker, a printer, a control system, and the like. In some embodiments, peripheral device 250 is a docking station. In other embodiments, peripheral device 250 comprises a consumer device have one or more functions for which an interface technology is required to access bus system 212.

Further examples of interface technologies coupled with specialized logic that may be used to connect peripheral devices 250 to bus(es)/interconnect(s) 212 include a serial port, a parallel port, a game port, a firewire (IEEE 1394), a wireless receiver, a video adapter, an audio adapter, a parallel port, a wireless transmitter, any parallel or serialized I/O peripherals or another interface.

Dynamic interface 218 enables processing unit 200 to exchange information with one or more peripheral devices 250. A connection between processing unit 200 and peripheral device 250 may further include additional hardwired and/or wireless links. In some embodiments, peripheral device 250 comprises a plurality of functionalities, each functionality accessing system bus 212 and processing unit 200 via a unique interface technology, as described below.

In some embodiments, peripheral device 250 comprises a plurality of contacts 260 corresponding to at least one of the zoned circuits 230 of the dynamic port 218. Accordingly, device 250 is operably coupled to dynamic interface 218 by interconnecting contacts 260 with circuits 230. One having skill in the art will appreciate that an operable connection between device 250 and interface 218 may be accomplished by any number of possible techniques, structures and/or architectures commonly known and used in the art. For example, in some embodiments a keyed connection is provided between device 250 and interface 218. In other embodiments a wired connection is provided between device 250 and interface 218. Still further, in some embodiments a combination of wired and wireless connections are provided between device 250 and interface 218.

In some embodiments, peripheral device 250 comprises a plurality of application specific integrated circuits (ASICs) having a functionality for which access to system bus 212 is required. For example, in some embodiments peripheral device 250 comprises a first ASIC 252 requiring access to system bus 212 via a PCIe interface 232. In other embodiments, peripheral device 250 further comprises a second and third ASIC 254 and 256 requiring access to system bus 212 via SATA interface connections 234 and 236. Accordingly, first, second and third ASICs 252, 254 and 256 are operable connected to contacts 260 corresponding to the required interface technology, 232, 234 and 236, respectively.

In some embodiments, peripheral device 250 further provides a push-through circuit 270 whereby unused or intermittently used interface resources are pushed through the device and made available to an external contact or port 272. In other embodiments, peripheral device 250 further provides a pass-through circuit 280 wherein an non-accessed resource is passed through the device and made available to an external contact or port 282. Thus, peripheral device 250 may include access features 272 and 282 whereby to couple additional peripheral devices to processing unit 200 via peripheral device 250.

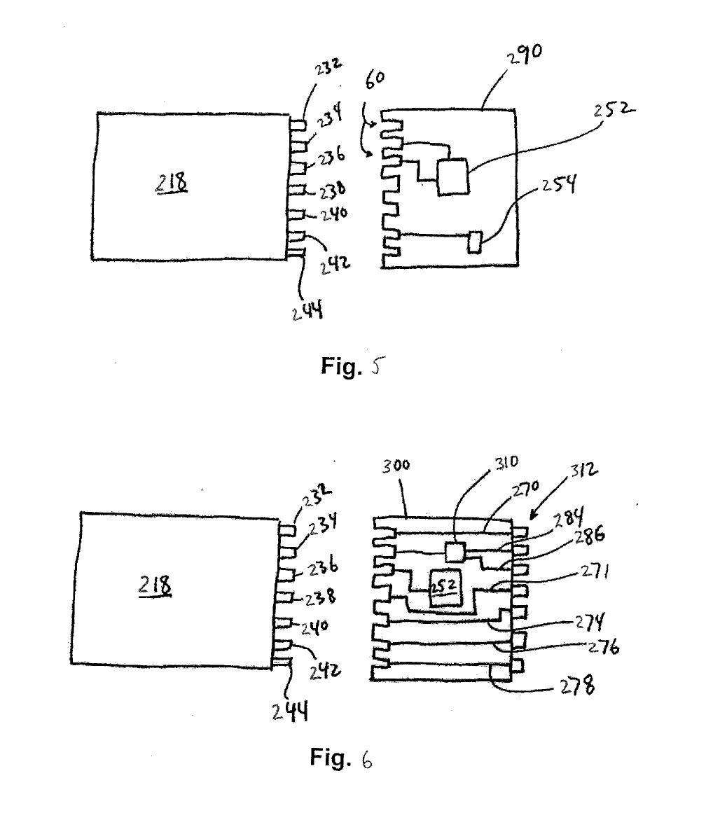

Referring now to FIG. 5, in some embodiments a peripheral device 290 is provided having a structure and configuration whereby the device 290 solely consumes the required interface technologies. For example, in some embodiments peripheral device 290 comprises a first ASIC 252 requiring two SATA connections 234 and 236, and a second ASIC 254 requiring a PMBus interface connection 242. In contrast to peripheral device 250, peripheral device 290 does not offer or provide pass-through or push-through circuits for the remaining available interface technologies. Rather, peripheral device 290 only consumes those interface technologies needed access system bus 212 of processing unit 200.

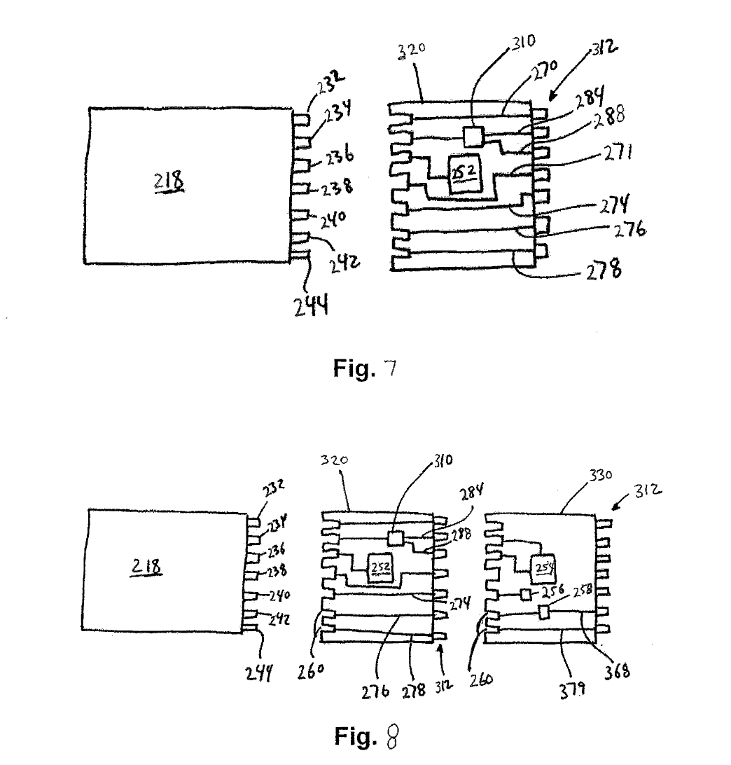

With reference to FIG. 6, in some embodiments a peripheral device 300 is provided having a structure and configuration whereby the device 300 consumes and passes through the various interface technologies. For example, in some embodiments peripheral device 300 comprises a first ASIC 252 requiring a single SATA connection 236. However, peripheral device 300 further provides pass-through circuits 270, 271, 74, 76 and 78 for interface technologies 32, 38, 40, 42 and 44, respectively. To pass through interface technologies 234 and 236, an SATA splitter 310 is provided whereby interface technology 234 is split to provide pass-through circuits 284 and 286 for external contacts or ports 312. Thus, a secondary peripheral device (not shown) may be coupled to external contacts 312 via SATA interface technology.

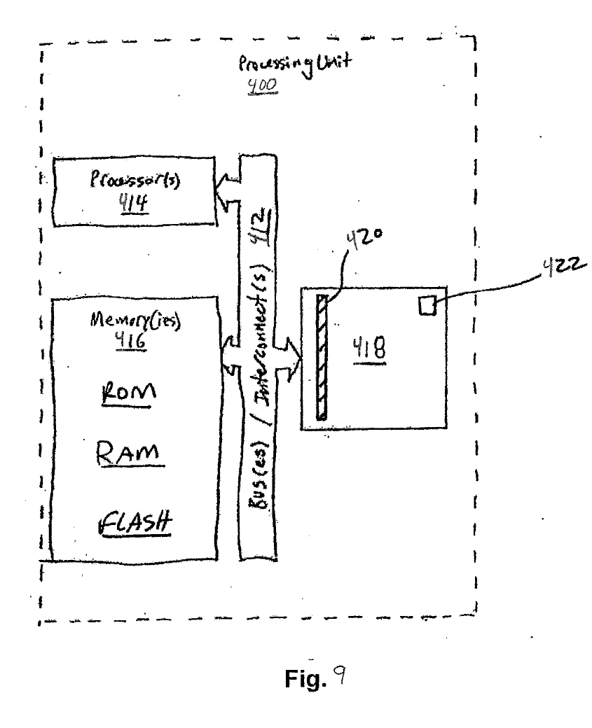

Referring now to FIG. 7, in some embodiments a peripheral device 320 is provided having a structure and configuration whereby the device 320 consumes an entire interface technology yet needs to pass-through the consumed technology to an external contact or port. For example, in some embodiments peripheral device 320 comprises a first ASIC 252 requiring multiple SATA connections 234 and 236. However, peripheral device 320 further provides pass-though circuits 271, 274, 276 and 278 for interface technologies 232, 238, 240, 242 and 244, respectively. As both SATA connections are consumed by ASIC 252, a splitter 310 is provided whereby technology 232 is split to provide a pass-through circuit 270 and a replicated SATA circuit 288 for external contacts or ports 312. Thus, a secondary peripheral device (not shown) may be coupled to external contacts 312 via SATA interface technology.

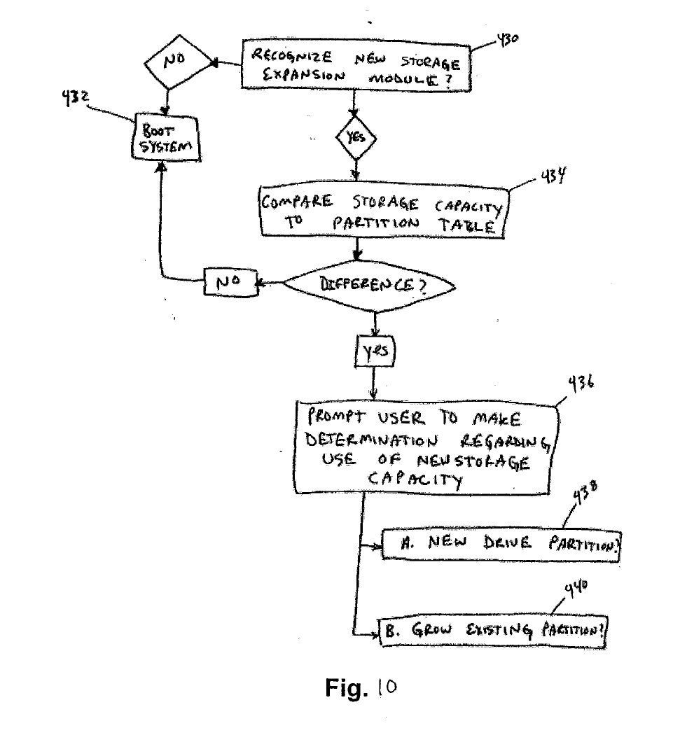

Referring now to FIG. 8, in some embodiments a secondary peripheral device 330 is operably connected to dynamic interface 218 via a first peripheral device 320. As previously discussed, first peripheral device 320 includes splitter 310 whereby a single SATA interface circuit is split to provide two SATA pass-though circuits 284 and 286 at external contacts 312. First peripheral device 320 further includes pass-through circuits 274, 276 and 278 to provide interface technologies 240, 242 and 244, respectively, at external contacts 312.

Secondary peripheral device 330 comprises a second ASIC 254 requiring multiple SATA interface connections, a third ASIC 256 requiring an I²C interface connection, and a fourth ASIC 258 requiring a PMBus interface connection. Device 330 further requires a power pass-through circuit 279. As previously discussed, first peripheral device 320 is so configured as to provide all the necessary pass-though circuits to accommodate the requirements of secondary peripheral device 330. Device 330 further includes push-though circuit 268 and power pass-through circuit 279 whereby to provide PMBus and power circuits, respectively, at external contacts 312.

### Multi-Link Dynamic Storage Partitioning

At least some aspects of the present invention further relate to a system and method for providing an expandable storage drive. In particular, certain aspects of the present invention relate to an openly connected dynamic storage system whereby the storage capacity of a processing unit is increased by coupling additional storage components to the processing unit via a dynamic interface connector that is interposedly connected.

Some embodiments of the present invention embrace an expandable storage drive that may be employed in association with all types of computer and/or electrical enterprises. The expandable storage drive allows for continued expansion of storage capacity with data preservation. The expandable storage drive further allows for on-the-fly storage expansion without losing data or requiring data transfer. Thus, in some embodiments a processing unit is provided having a first storage configuration with a defined amount of storage capacity. The processing unit is then allowed to expand to a second storage configuration with a defined amount of storage capacity that is greater than the first storage configuration.

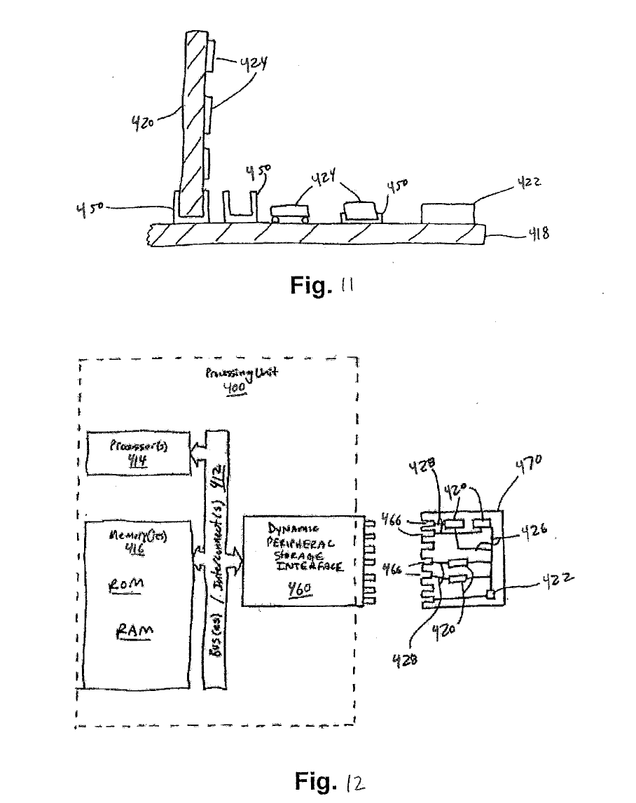

FIG. 9 and the corresponding discussion are intended to provide a general description of a suitable operating environment in accordance with embodiments of the present invention. As will be further discussed below, embodiments of the present invention embrace the use of one or more multi-link dynamic interface connectors in a variety of customizable configurations to provide an expandable storage drive.

With reference to FIG. 9, a representative host controller includes a processing unit 400, which may be used as a general-purpose or special-purpose processing unit. For example, processing unit 400 may be employed alone or with one or more similar processing units as a personal computer, a notebook computer, a personal digital assistant (“PDA”) or other hand-held device, a workstation, a minicomputer, a mainframe, a supercomputer, a multi-processor system, a network computer, a processor-based consumer device, a smart appliance or device, a control system, or the like. Using multiple processing units in the same host controller provides increased processing capabilities. For example, each processing unit of a host controller can be dedicated to a particular task or can jointly participate in distributed processing.

In FIG. 9, processing unit 400 includes one or more buses and/or interconnect(s) 412, which may be configured to connect various components thereof and enables data to be exchanged between two or more components. Bus(es)/interconnect(s) 412 may include one of a variety of bus structures including a memory bus, a peripheral bus, or a local bus that uses any of a variety of bus architectures. Typical components connected by bus(es)/interconnect(s) 412 include one or more processors 414 and one or more memories 416, such as RAM, ROM, or flash memories.

In some embodiments, processing unit 400 further includes a dynamic storage interface 418 operably coupled to system bus 412. Interface 418 may include any structure or means whereby a storage module 420, such as flash bars, may be operably coupled to the interface in a dynamic manner. For example, in some embodiments a storage module 420 is soldered to a contact of interface 418. In other embodiments, a storage module 420 is inserted into a slot on interface 418 thereby operably coupling the storage module 420 to the interface. Still further, in some embodiments a plurality of storage modules 420 are operably coupled to dynamic storage interface 418.

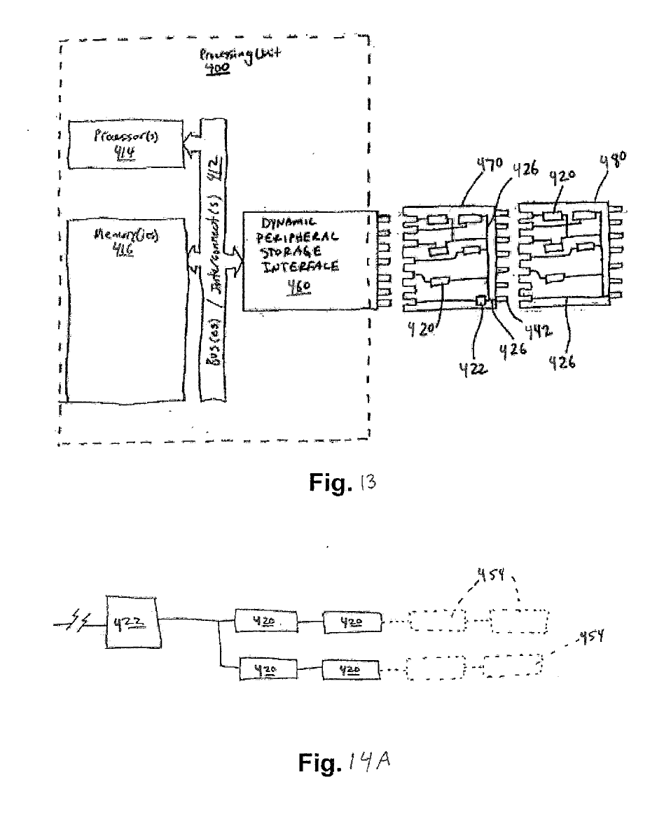

In some embodiments, dynamic storage interface 418 further comprises a flash controller 422. Flash controller 422 recognizes storage module 420 and controls access to and from storage module 420. As additional storage modules (not shown) are added to storage interface 418, flash controller 422 recognizes the new storage module as a memory expansion module prompting the processing unit BIOS to rectify inaccuracies between the partition table and the detected storage capacity. In some embodiments, processing unit 400 further comprises a computer executable program that prompts the user to make a determination regarding the new storage module, as shown in FIG. 10.

Referring now to FIG. 10, a software method for making a determination regarding the addition of a new storage module is shown. A first step 430 involves the recognition of a new storage expansion module. This step is initially performed by the flash controller 422. If no new storage is detected, BIOS will boot the system 432. If new storage is recognized, BIOS will compare the new storage capacity to the storage capacity value recorded in the partition table 434. If the storage capacity of the partition table is the same as the new storage capacity, BIOS will boot the system 432. If there is a discrepancy between the two values, BIOS will prompt the user to make a determination regarding how the processing unit should use the new storage capacity 436. The program will prompt the user to select one of two options: a) partition the storage capacity as a new drive 438; or b) grow the existing storage capacity of the existing drive 440. Depending upon the user's response, the software will update BIOS and the partition table to reflect any necessary updates.

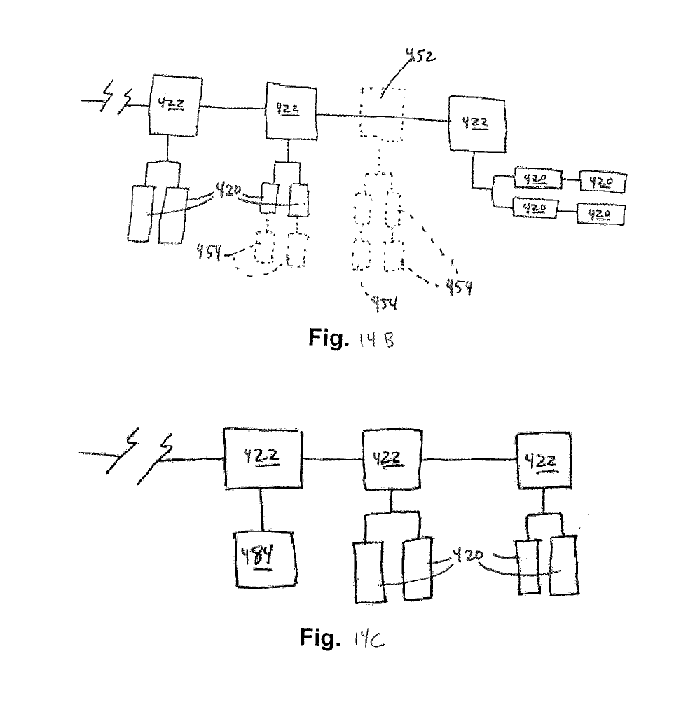

Referring now to FIG. 11, a cross-section side view of dynamic storage interface 418 is shown. In some embodiments, storage interface 418 comprises a plurality of clips or slots 450 for operably receiving storage modules 420. Storage module 420 may include any form, structure, technology or combination thereof of storage media. For example, in some embodiments storage module 420 comprises a PCB having a plurality of flash bars 424 operably connected thereto. In other embodiments, storage module 420 comprises individual flash bars 424 directly and operably coupled to storage interface 418, such as by soldering. Further, in some embodiments storage module 420 comprises individual flash bars 424 operably connected to a clip or slot 450 operably connected to dynamic storage interface 418.

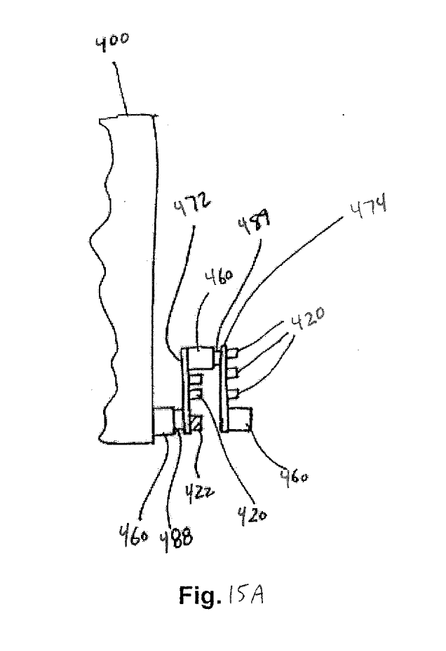

Referring now to FIG. 12, in some embodiments processing unit 400 further comprises a dynamic peripheral storage interface 460. Peripheral storage interface 460 is operably coupled to system bus 412 and the various other computing components described above. In some embodiments, a peripheral storage device 470 is operably coupled to peripheral storage interface 460 by a known method in the art. For example, in some embodiments storage device 470 is coupled to interface 460 via a keyed interface connection.

In some embodiments, peripheral storage device 470 comprises a plurality of storage modules 420 and a flash controller 422. The storage modules 420 are operably connected to flash controller 422 via a flash controller circuit 426. Further, in some embodiments storage modules 420 are operably connected to contacts 466 via memory circuits 428. Thus, when storage device 470 is interconnected with dynamic peripheral storage interface 460 processor 414 of the processing unit 400 is able to access, recognize and utilize storage modules 420.

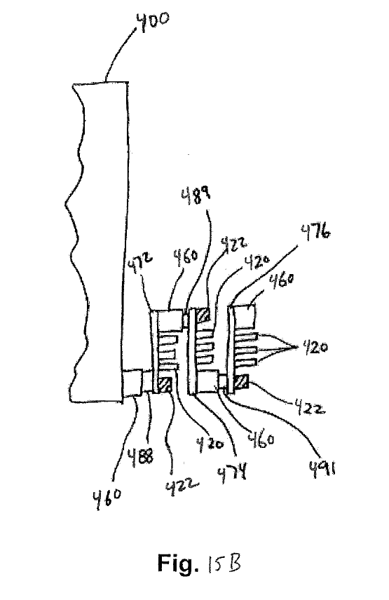

Referring now to FIG. 13, in some embodiments a second peripheral storage device 480 is coupled to, or piggybacked onto peripheral storage device 470, thereby dynamically increasing the storage capacity of processing unit 400. A notable distinction between peripheral storage device 470 and peripheral storage device 480 is the absence of a flash controller on storage device 480. In some embodiments, flash controller 422 on storage device 470 is electrically coupled to storage device 480 via flash controller circuit 426 and connector 442. Accordingly, flash controller 422 is passed through connector 442 to storage device 480. Once connected, flash controller 422 controls storage modules 420 of storage device 480 via flash controller circuit 426 on device 480. Thus, rather than replicating the flash controller with each new storage module, a single flash controller 422 is used to control all available storage modules 420 as a single storage drive.

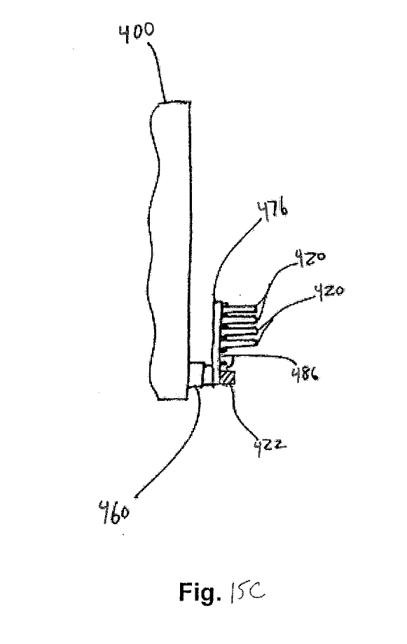

One having skill in the art will appreciate that additional peripheral storage may be added to the system to further increase the storage capacity of the processing unit 400. For example, as shown in FIG. 14A, in some embodiments additional storage modules 420 are added to flash controller 422 thereby growing the memory capacity of processing unit 400. The memory capacity of processing unit 400 is further expanded by adding additional memory modules 454, as desired. In some embodiments, memory modules 420 are added to flash controller 422 in at least one of a parallel and a serial circuit configuration. Thus, as each new module 422 or 454 is added to controller 422, the control function of controller 422 is expanded to include the memory.

Referring now to FIG. 14B, in some embodiments a plurality of flash controllers 422 are arranged in a serial circuit, wherein each controller 422 comprises its own set of memory modules 420. Memory modules 420 are controlled by their respective controllers 422, wherein each controller comprises its own memory capacity based on the number and size of memory modules 420. In some embodiments, an additional memory partition is added to processing unit 400 by adding an addition controller 452 having additional memory modules 454.

In some embodiments, processing unit 400 further comprises a flash controller 422 having a redundant array of independent disks (RAID) 484, as shown in FIG. 14C. Thus, in some embodiments the reliability of the processing unit 400 is increased by combining multiple memory modules into a logical unit 484 where all of the modules in the array are interdependent. For example, in some embodiments RAID 484 is a RAID-5 volume using three 250 GB flash memory modules, wherein two of the memory modules are for data, and the third memory module is for parity. In other embodiments, processing unit 400 comprises a plurality of RAIDs 484 operably interconnected to system bus 412.

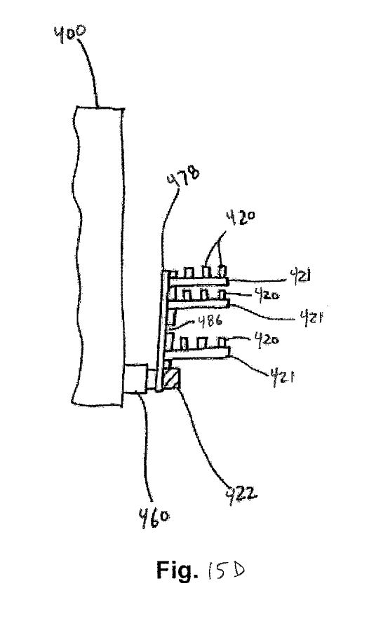

Referring now to FIGS. 15A through 15D, in some embodiments a peripheral storage device 472 is operably connected to system bus 412 via a dynamic peripheral interface 460. With reference to FIG. 15A, in some embodiments a first peripheral storage device 472 is operably connected to dynamic interface 460 via a keyed connection 488. In some embodiments, first peripheral device 472 comprises a flash controller 422 and a plurality of memory modules 420. A second peripheral storage device 474 is further coupled to first peripheral device 472 via a second keyed connection 489. In some embodiments, second peripheral device 474 does not contain a controller, but rather only contains memory modules 420 that are controlled by flash controller 422 of first storage device 472. Second peripheral device 474 further comprises a dynamic interface 460 for receiving additional peripheral devices (not shown). Thus, by operably stacking additional peripheral devices, the storage capacity of processing unit 400 is dynamically expanded.

With reference to FIG. 15B, in some embodiments a plurality of peripheral devices 472, 474, and 476 are operably interconnected via keyed connections 488, 489 and 491. Further, in some embodiments each peripheral device 472, 474, and 476 comprises a flash controller 422 to independently control the memory modules 420 operably coupled to each device. In this manner, each additional peripheral device is seen by the processing unit 400 as a new memory partition or drive thereby increasing the storage capacity of the system. Still further, in some embodiments peripheral device 476 comprises an additional dynamic interface 460 whereby to receive an additional peripheral device, such as an additional storage device. In other embodiments, interface 460 of device 476 is provided to operably receive a non-storage based peripheral device.

In some embodiments, peripheral device 476 comprises a flash controller 422 and a plurality of sockets, ports, or docks 486 by which to operably couple memory modules 420 to processing unit 400 via dynamic interface 460. Thus, in some embodiments the storage capacity of processing unit 400 is dynamically increased by adding a memory module 420 to an empty socket 486.

Still further, in some embodiments peripheral device 478 comprises a flash controller 422 and a plurality of sockets 486 by which to operably couple dynamic memory modules 421 to processing unit 400 via dynamic interface 460. In some embodiments, dynamic memory modules 421 comprise a PCB having a plurality of sockets or contacts by which to operably and dynamically couple memory modules 420 to the PCB. In some embodiments, each dynamic memory module 421 comprises a plurality of memory modules 420 which are collectively controlled by flash controller 422. In other embodiments, each module 421 comprises an independent flash controller (not shown) whereby each dynamic memory module 421 performs as a separate memory partition for processing unit 400.

In some embodiments, dynamic peripheral storage interface 460 further includes additional functionalities which are passed through the various peripheral storage devices. For example, in some embodiments a power source is passed through interconnected peripheral devices to power a downstream peripheral device. In other embodiments, an interface technology, such as USB, PMBus SATA, or I²C is passed through the interconnected peripheral devices to enable communication between the interconnected devices and the processing unit 400. Further, in some embodiments an interface technology is passed through the interconnected peripheral devices to enable communication between a downstream device and the processing unit 400.

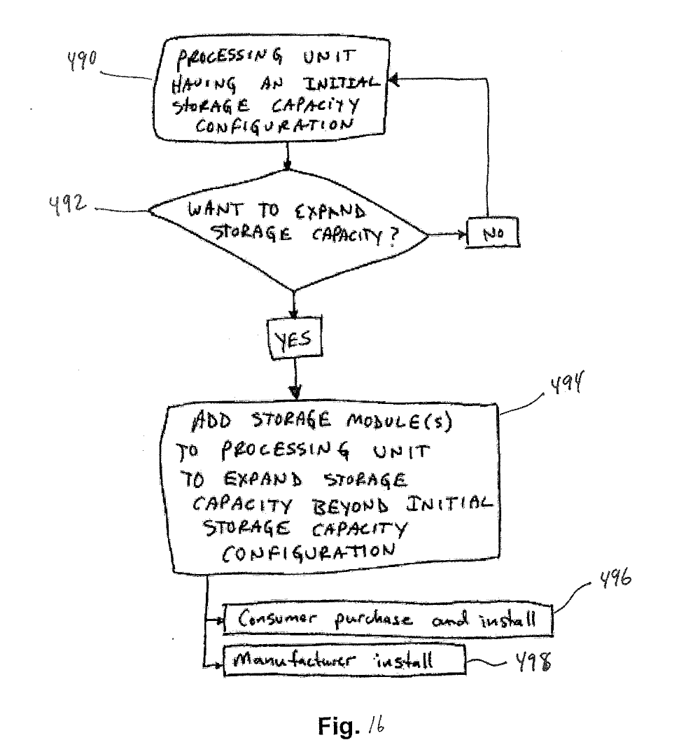

Referring now to FIG. 16, a method for dynamically expanding the storage capacity of processing unit device is shown. For some methods, a first step 490 is to purchase or possess a processing unit 400 having an initial storage capacity configuration. A second step 492 is to make a determination to expand the storage capacity of the processing unit 400. A third step 494 is to add storage module(s) to the processing unit 400 thereby expanding the storage capacity of the storage unit beyond the initial storage capacity configuration. This step 494 may be accomplished by either a) the computer user purchasing and installing additional storage modules 496, or b) the manufacturer or computer technician install the additional storage modules 498 in the processing unit 400.

One having skill in the art will appreciate that dynamic storage interface 418, storage module 420, dynamic peripheral storage interface 460 and peripheral storage devices 470 and 480 may include any type or combination of interface technologies as desired for a specific application. Further, one having skill in the art will appreciate that advances in computing technology may provide additional interface technologies that are compatible with the present invention and are therefore included within the spirit of the present invention.

One having skill in the art will further appreciate that an operable connection between devices 470, 480 and interfaces 418 and 460 may be accomplished by any number of possible techniques, structures and/or architectures commonly known and used in the art. For example, in some embodiments a keyed connection is provided between peripheral devices and interface 460. In other embodiments a wired connection is provided between peripheral devices and interface 460. Still further, in some embodiments a combination of wired and wireless connections are provided between the operably interconnected devices and interfaces of the present invention.

### Multi-Link Dynamic PCIE Partitioning

It will be readily understood that at least some components of the present invention, as generally described and illustrated in the following figures, could be arranged and designed in a wide variety of different configurations. Thus, the following embodiments of the system and method of the present invention as shown and represented in FIG. 16, is not intended to limit the scope of the invention, as claimed, but is merely representative of some of the presently preferred embodiments of the invention.

PCIe utilizes a serial connection that operates similarly to a network instead of the bus system used in parallel operation. Instead of one bus that handles data from multiple sources, PCIe has a switch that controls several point-to-point serial connections. These connections start at the switch and lead directly to the devices where the data needs to go. Every device has its own dedicated connection, so devices no longer share bandwidth like they do on a bus.

PCIe architecture is structured around the point-to-point serial links, which when paired (one in each direction) comprise a lane. A hub on a main-board, acting as a crossbar switch, routes the lanes. The dynamic point-to-point architecture permits several devices to communicate with each other simultaneously. The architecture also permits splitting and/or grouping of lanes.

In the present invention unrelated lanes running to a single connector can be grouped or split depending on the configuration of the card. Accordingly, multiple devices can be placed on a single card and the appropriate number of lanes can be allocated to each device on the card to maximize their performance. Providing flexibility in grouping lanes allows greater flexibility in designing cards and in replacing cards as needed to optimize the machine's desired performance.

The number of lanes allocated to each device is determined during initialization of the bios. In the present invention, multiple unrelated groups are run to a connector to permit use of one or more of the available lanes. Indeed, unrelated PCIe lanes are run to the same connector. By running unrelated PCIe lanes to a single connector, a single card can run multiple devices and each device can have the requisite number of lanes allocated to the device to optimize each device's function.

While PCIe makes the lane count flexible, the grouping of unrelated lanes improves flexibility of card design to allow a connector to effectively service both a high bandwidth card, such as a video card or a high speed internet card, as well as multiple, unrelated, low bandwidth devices housed on the same card. A link, which comprises point-to-point communication channel(s) between 2 PCIe ports, allows both send/receive of ordinary PCI-requests (configuration read/write, I/O read/write, memory read/write) and interrupts (INTx, MSI, MSI-X). At the physical level, a link comprises 1 or more lanes. Low-speed peripherals (such as an 802.11 Wi-Fi card) use a single-lane (×1) link, while a graphics adapter typically uses a much wider (and thus, faster) 16-lane link.

A lane comprises a transmit and receive pair of differential lines. Each lane comprises 4 wires or signal paths, thus each lane is a full-duplex byte stream, transporting data packets in 8 bit ‘byte’ format, between endpoints of a link, in both directions simultaneously. Physical PCIe slots may contain from one to thirty-two lanes, in powers of two (1, 2, 4, 8, 16 and 32).

In certain embodiments of the present invention a modified PCI protocol is used to dynamically partition PCIe lanes and allocate, by either grouping or splitting, lanes according to the demands of a device on a PCIe card. In certain embodiments of the present invention, the bios determines which devices on a card are plugged into the motherboard during initialization and dynamically partitions PCIe lanes based on the PCIe card's requirements. The lanes are dynamically partitioned during the BIOS initialization when the devices on the card, along with the lanes required for each devices to properly operate, are identified and allocated.

In certain alternative exemplary embodiments of the invention, a different card can replace the original card and a different grouping of lanes may be allocated during initialization to permit optimal allocation, the lane allocation is modified and can be grouped or split, without regard for the relation to the lanes to the other lanes. In this way the lane allocation is always optimized and no lane that could be utilized is left unused because of the original grouping.

Still other embodiments provide for improved flexibility of card design. By dynamically partitioning lanes based on each card's unique requirements, card designers are provided greater flexibility to place multiple, unrelated devices on a single card and allocate lanes to those devices in an optimal way. In one embodiment a card may provide for a device which requires 4 lanes and also include several devices which only require one lane. Additional alternative embodiments may include grouping unrelated lanes connected to the same connector.

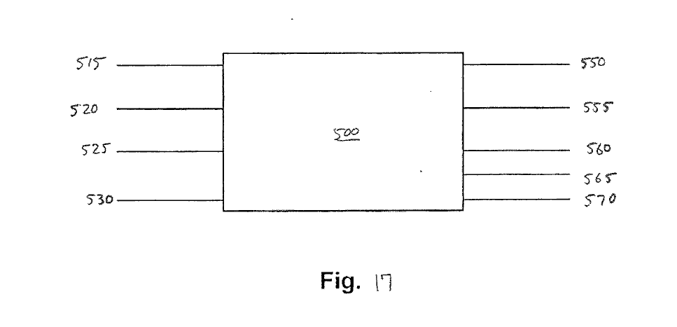

Referring now to FIG. 17, a block diagram of PCIe routing is shown. A PCIe bridge 500 is provided with lanes 515, 520, 525, 530, 550, 555, 560, 565, and 570 connected thereto. If lane 515 comprises 8 lanes, those lanes can be split. Similarly, if lanes 520, 525, and 530 can be grouped even if the lanes are unrelated. Similarly, if lane 550 was an 8 lane connection it too could be split. Just as if lanes 560, 565, and 570 were each 1 lane they could be grouped. The grouping or splitting of lanes is flexible to permit the allocation of lanes in the optimal configuration and to permit greater flexibility in card design.

Data transfers serially in a PCIe as packets moving across the lane at a rate of one bit per cycle. Each lane of the PCIe connection contains two pairs of wires—one to send and one to receive. An ×1 connection has one lane made up of four wires which carries one bit per cycle in each direction. Similarly, a ×2 link contains eight wires and transmits two bits at once, a ×4 link transmits four bits, and so on. Other configurations are ×12, ×16 and ×32.

This illustration is merely exemplary of the capabilities of one or more grouping configurations. Indeed, while illustrative embodiments of the invention have been described herein, the present invention is not limited to the various preferred embodiments described herein, but rather includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” is expressly recited; and b) a corresponding function is expressly recited.

The present invention may be embodied in other specific forms without departing from its spirit or essential characteristics. The described embodiments are to be considered in all respects only as illustrative and not restrictive. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer processing unit, comprising:
a video controller;
a DVI-I connector;
and a DisplayPort connector,
wherein the DVI connector and the DisplayPort connector are electrically connected to the video controller.

2. The computer processing unit of claim 1, wherein the DVI connector comprises a DVI-I connector.

3. The computer processing unit of claim 2, wherein the DVI-I connector comprises a dual-link DVI-I connector.

4. The computer processing unit of claim 1, wherein a VGA to VDI dongle is electrically connected to the DVI connector for supporting a VGA display.

5. The computer processing unit of claim 1, wherein a DVI to HDMI dongle is electrically connected to the DVI connector.

6. The computer processing unit of claim 1, wherein a Y-splitter comprising a VGA connector and a second DVI connector is attached to the DVI connector.

7. The computer processing unit of claim 1, further comprising:
a printed circuit board having a central processing unit, wherein the printed circuit board is routed to electrically connect with a plurality of boards having different combinations of video display connectors, wherein the plurality of boards are selected from an input/output board and a power supply board; and
a BIOS that includes BIOS information for each of the different combinations of video display connectors.

8. A dynamic interface, comprising a plurality of circuits operably connected to a processing unit via a system bus, the plurality of circuits including two or more interface technologies, the dynamic interface further being operably connected to a peripheral device.

9. The interface of claim 8, wherein the dynamic interface is a PCIe interface comprising a plurality of unrelated lanes connected to a connector.

10. The interface of claim 8, wherein the two or more interface technologies are selected from the group consisting of a USB interface, a PCI-express interface, a SATA interface, an I²C interface, and a PMBus interface.

11. The interface of claim 8, wherein the processing unit further comprises at least one of a non-peripheral based encasement, a cooling process, an optimized circuit board configuration, optimized processing ad memory ratios, and a dynamic back plane.

12. The interface of claim 8, wherein the dynamic interface is further directly connected to the system bus of the processing unit.

13. The interface of claim 8, wherein the plurality of circuits is a plurality of zoned circuits.

14. The interface of claim 8, wherein the plurality of circuits comprises at least one pass-through circuit.

15. The interface of claim 8, wherein the peripheral device further comprises a dynamic interface that is operably connected to a second peripheral device.

16. A dynamic expandable storage drive comprising a dynamic storage interface for receiving a plurality of storage modules, the dynamic expandable storage drive having a storage capacity that is expanded by adding an additional storage module to the dynamic storage interface.

17. The storage drive of claim 16, wherein the plurality of storage modules comprise at least one of RAM, ROM, and flash memories.

18. The storage drive of claim 16, wherein the storage interface further comprises a flash controller.

19. The storage drive of claim 18, wherein the flash controller is operably connected to a BIOS of a processing unit via a system bus.

20. The storage drive of claim 19, wherein the flash controller prompts the BIOS to rectify an inaccuracy between a partition table and a detected storage capacity of the processing unit.
